(19) United States
(12) Patent Application Publication
(10) Pub. No.: US 2003/0146040 A1
(43) Pub. Date: Aug. 7, 2003

(54) Dual-mode drive-by-wire steering system

(76) Inventors: Ronald Henry Dybalski, Oxford, MI (US); David W. Ha, Rochester Hills, MI (US); Brian Birrell, Chesterfield, MI (US)

Correspondence Address: DELPHI TECHNOLOGIES, INC., Legal Staff, P.O. Box 5052, Mail Code: 480-414-420, Troy, MI, 48007-5052, US

(21) Appl. No.: 10/066,834

(22) Filed: Feb. 4, 2002

(51) Int. Cl. B62D 5/06

(52) U.S. Cl. 180/446; 180/443

(57) ABSTRACT

A dual-mode steering system (12) for an automotive vehicle (14) includes a first steering mechanism (36) and a second steering mechanism (38). A locking mechanism (72) is mechanically coupled to the first steering mechanism (36) and the second steering mechanism (38). The system (12) also includes a locking switch (40) having a first state and a second state. A controller (22) is electrically coupled to the locking mechanism (72) and the locking switch (40). The controller (22) locks the first steering mechanism (36) to the second steering mechanism (38) when the locking switch (40) is in the first state and disengages the first steering mechanism (36) from the second steering mechanism (38) when the locking switch (40) is in the second state. A method of operating the dual-mode steering system (12) is also provided.

### TECHNICAL FIELD

The present invention relates generally to automotive vehicle systems, and more particularly, to a method and system for steering an automotive vehicle having dual steering apparatuses.

### BACKGROUND OF THE INVENTION

Conventional automotive vehicles are maneuvered through the use of a steering wheel. Other, perhaps more modern or futuristic approaches for vehicle steering have been proposed, such as steering by use of a joystick or the like. The modern approaches have been more favored by younger generations and found to be rather undesirable by older generations. Older generations find comfort in driving traditional steering systems and are reluctant to change. As with any new system, change is difficult. Conventional steering has been around for many years and has become almost second nature to many individuals.

Space within vehicles has become sparse due to multiple vehicle requirements, some of which include a continuous demand for additional creature comforts and improved vehicle performance, as well as fuel economy restrictions, and increasing safety requirements. Steering by joystick aids in satisfying several of these requirements and at the same time increases available interior space.

Joystick steered vehicles provide several advantages over traditionally steered vehicles. By not having a conventional steering wheel located forward of an operator, a large amount of space is “freed up” in a vehicle dashboard and in an interior area between the operator and the dashboard of the vehicle. Additionally, many vehicle components traditionally used to couple a steering wheel to wheels of a vehicle become obsolete or not necessary. The reduction in vehicle components reduces weight and production costs of the vehicle. Reducing the weight of the vehicle conserves on fuel consumption and can increase performance of the vehicle; all other factors being equal.

The extra available space within the vehicle allows an operator to move more freely within the vehicle and to use the space where a steering wheel would normally be placed for other purposes. This added freedom of movement and available space provides the operator with increased comfort. The driver may use a personal laptop computer, while the vehicle is at a standstill, or perform other activities that could not normally be performed in conventionally steered vehicles.

The removal of the steering wheel can also increase driver visibility of an environment outside of the vehicle and an open view of a vehicle instrument panel. An increase in driver visibility increases driver awareness and, in turn occupant safety. Also, additional occupant safety features may be incorporated into the vehicle, due to the additional available space.

There is a continuous effort to improve the functionality and cost of automotive vehicles. Joystick steered vehicles and other modern steering systems can provide multiple advantages over traditional steering systems. Therefore, it would be desirable to provide a steering system that bridges the gap between younger generation operators and older generation operators, thereby, satisfying both generations, while at the same time providing the benefits of more modern steering systems.

### SUMMARY OF THE INVENTION

The foregoing and other advantages are provided by a method and apparatus for steering an automotive vehicle having dual steering apparatuses. One of several advantages of the present invention is that it provides an apparatus and method for steering a vehicle utilizing drive-by-wire technology in such a manner that satisfies both older generations and younger generations. The satisfaction of both generations originates from the fact that the present invention provides dual-mode steering apparatuses, one of which being similar to that of conventional steering and the other being similar to that of steering by a joystick.

Another advantage of the present invention is that it incorporates the advantages of steering by joystick. As with vehicles having joystick steering, the present invention has fewer vehicle components than conventional steering systems, thereby reducing vehicle weight, fuel consumption, and production costs. The decrease in vehicle weight also can increase vehicle performance, assuming that all other factors are the same.

The present invention also provides increased driver comfort by providing increased space within the vehicle when the vehicle is at a standstill. The operator may retract steering mechanisms of the present invention and use the available space to operate a laptop computer or perform other tasks, not normally easily accomplished with the presence of a traditional steering wheel.

The present invention further provides for increased visibility of a vehicle instrument panel and of the environment forward of the vehicle. The increased visibility provides increased operator awareness.

A dual-mode steering system for an automotive vehicle is provided. The system includes a first steering mechanism and a second steering mechanism. The first steering mechanism includes an articulatable member. The second steering mechanism includes a center hub assembly and a first extending arm. The first extending arm is mechanically coupled to the articulatable member and the central hub assembly. A locking mechanism is mechanically coupled to the first steering mechanism and the second steering mechanism. A locking switch having a first state and a second state is also included. A controller is electrically coupled to the locking mechanism and the locking switch. The controller locks the first steering mechanism to the second steering mechanism when the locking switch is in the first state and disengages the first steering mechanism from the second steering mechanism when the locking switch is in the second state.

A method of operating the dual-mode steering system is also provided. The method includes switching the locking switch to either the first state or the second state. The first steering mechanism is locked to the second steering mechanism to form a combined steering mechanism when the locking switch is in the first state. In the alternative, the first steering mechanism is unlocked from the second steering mechanism when the locking switch is in the second state. The combined steering mechanism or the first steering mechanism is rotated when said locking switch is in the first state or the second state, respectively, to steer the vehicle.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a block diagrammatic view of a vehicle guidance system utilizing a dual-mode steering system for an automotive vehicle in accordance with an embodiment of the present invention;

FIG. 2 is a perspective view of the dual-mode steering system in accordance with an embodiment of the present invention;

FIG. 3 is a front view of a first steering mechanism and a second steering mechanism in accordance with an embodiment of the present invention;

FIG. 4 is a front view of a first steering mechanism having a connecting member in accordance with another embodiment of the present invention;

FIG. 5 is a perspective view of a central hub assembly for a dual-mode steering system in accordance with an embodiment of the present invention;

FIG. 6 is a top view of a second steering mechanism coupled to a retractable steering arm in accordance with an embodiment of the present invention;

FIG. 7 is a side view of a locking mechanism in accordance with an embodiment of the present invention; and

FIG. 8 is a schematic flow diagram illustrating a method of operating the dual-mode steering system in accordance with an embodiment of the present invention.

### DETAILED DESCRIPTION OF THE PREFERRED EMBODIMENT

In each of the following figures, the same reference numerals are used to refer to the same components. While the present invention is described with respect to a method and apparatus for steering an automotive vehicle having dual steering apparatuses, the present invention may be adapted to be used in various systems including: automotive vehicle systems, control systems, hybrid-electric vehicle systems, navigation systems, or other applications utilizing a steering or vehicle guidance device.

In the following description, various operating parameters and components are described for one constructed embodiment. These specific parameters and components are included as examples and are not intended to be limiting.

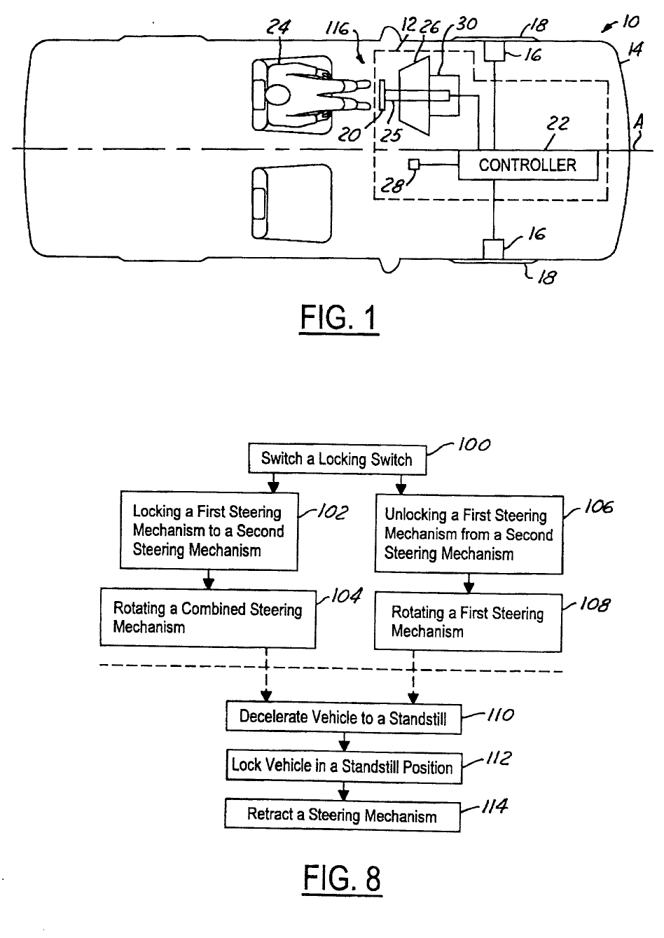

Referring now to FIG. 1, a block diagrammatic view of a vehicle guidance system 10 utilizing a dual-mode steering system 12 for an automotive vehicle 14 in accordance with an embodiment of the present invention is shown. The guidance system 10 includes the steering system 12, which is electrically coupled to a pair of wheel actuators 16. The steering system 12 signals the actuators 16 to pivot the wheels 18 as to guide the vehicle 14 in a desired direction of travel. The steering system 12 includes a dual steering mechanism 20 electrically coupled to a controller 22. As the steering mechanism 20 is rotated, by an operator 24, the controller 22 pivots the wheels 18 in a desired direction of travel corresponding to a steering mechanism rotational position. The steering system 12, as illustrated, uses drive-by-wire technology in steering the vehicle 14. Of course, the present invention may be utilized in combination with other vehicle steering technologies.

The controller 22 may be microprocessor based such as a computer having a central processing unit, memory (RAM and/or ROM), and associated input and output buses. The controller 22 may be a portion of a central vehicle main control unit, an interactive vehicle dynamics module, or a stand-alone controller. The controller 22 may also be of simply solid-state digital or analog logic devices.

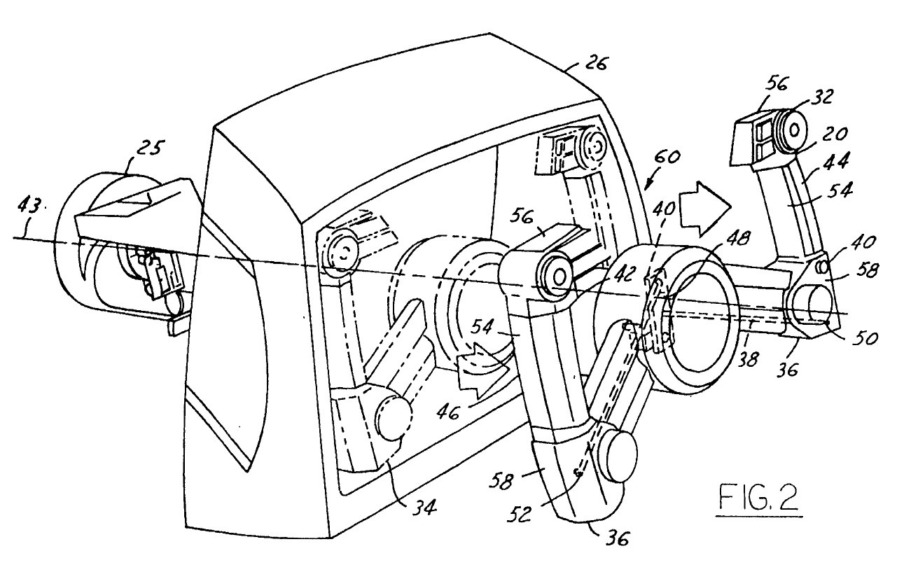

Referring now also to FIGS. 2 and 3, a perspective view of the steering system 12 and a front view of a first steering mechanism 36 and a second steering mechanism 38 are shown in accordance with an embodiment of the present invention. In an embodiment of the present invention, the steering mechanism 20 is coupled to a retractable steering arm 25 and is retractable into a steering system housing 26. Controller 22 via operator input, using a retracting switch 28, signals a steering arm motor 30 to extend or retract the steering mechanism 20 to either a usable operating condition 32 or to a retracted storage condition 34. The retracting switch 28 may operate, function, and be of any type or style known in the art. The arm 25 may also be collapsible, such that during a vehicle collision, the arm 25 can absorb energy of the operator 24, as known in the art with existing collapsible steering columns.

The preferred steering system 12 includes a first steering mechanism 36, a second steering mechanism 38, and a locking switch 40. Steering mechanisms 36 and 38 are operable in a first state or a second state, which are correspondingly associated with a first state and a second state of the switch 40. In the first state, the steering mechanisms 36 and 38 are locked together as a combined steering mechanism 42. The combined steering mechanism 42 may be rotated about a center hub axis 43 to steer the vehicle 14. In the second state, the first steering mechanism 36 is disengaged from the second steering mechanism 38. When disengaged, the first steering mechanism 36 is used alone to steer the vehicle 14 when in the second state, which is further described below. During the second state, the second steering mechanism 38 is inoperable and locked in a stationary position.

The first steering mechanism 36 articulates in a lateral direction perpendicular to a centerline that extends along the length of the vehicle 14. The first steering mechanism 36 includes a first articulating member 44, a second articulating member 46, and a linkage assembly 48 mechanically coupling the articulating members 44 and 46 together in order to operate in a synchronous manner. The first articulating member 44 and the second articulating member 46 may be actuated, separately or in unison, in a rotating fashion about a first pivot point 50 or a second pivot point 52, respectively. When only one of the articulating members 44 and 46 is actuated the linkage assembly 48 forces the non-actuated articulating member 44 or 46 to follow in suit.

The articulating members 44 and 46 include grips 54 for the operator 24 to rotate the articulating members 44 and 46 about respective pivoting points 50 and 52. The articulating members 44 and 46 include upper control portions 56 and lower control portions 58, both of which may contain various switches or controls for an in-vehicle stereo system, an air conditioning system, a cruise control system, or other vehicle systems known in the art. The upper control portions 56 are rigidly coupled to the grips 54. The lower control portions 58 are also rigidly coupled to the grips 54 but overlap the second steering mechanism 38, to allow the articulating members 44 and 46 to rotate on the pivot points 50 and 52 during operation.

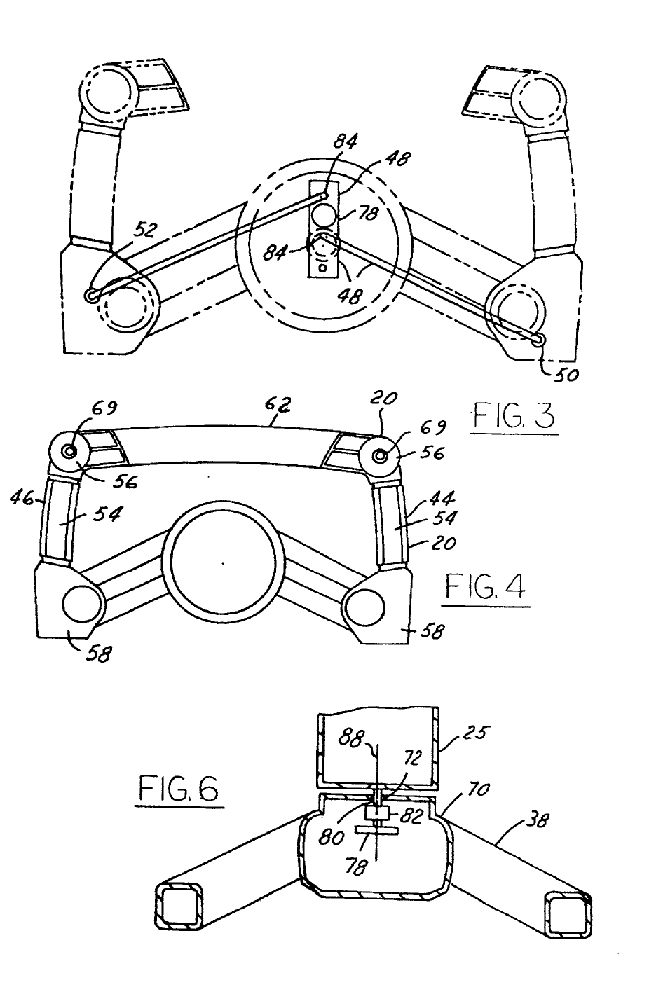

Although, the articulating members 44 and 46 are shown having a gap 60 between them, they may be coupled together by a connecting member 62, as best shown in FIG. 4. The gap 60 provides the operator 24 with a more open and less obstructed view of a vehicle instrument panel (not shown). Since the present invention uses drive-by-wire technology, hand-over-hand steering is not necessary when steering the vehicle 14 around a sharp turn. The steering mechanism 20 does not rotate more than approximately 90θ. Therefore, the connecting member 62 is not necessary, as in methods that may entail hand-overhand steering, but serves to satisfy vehicle operators that prefer driving with their hands towards the top of the steering mechanism 20. When the connecting member 62 or other connecting members, known in the art are used, the upper control portions 56 preferably have additional pivot points 69. The pivot points 69 allow the articulating members 44 and 46 to rotate freely about pivoting points 50 and 52 without binding.

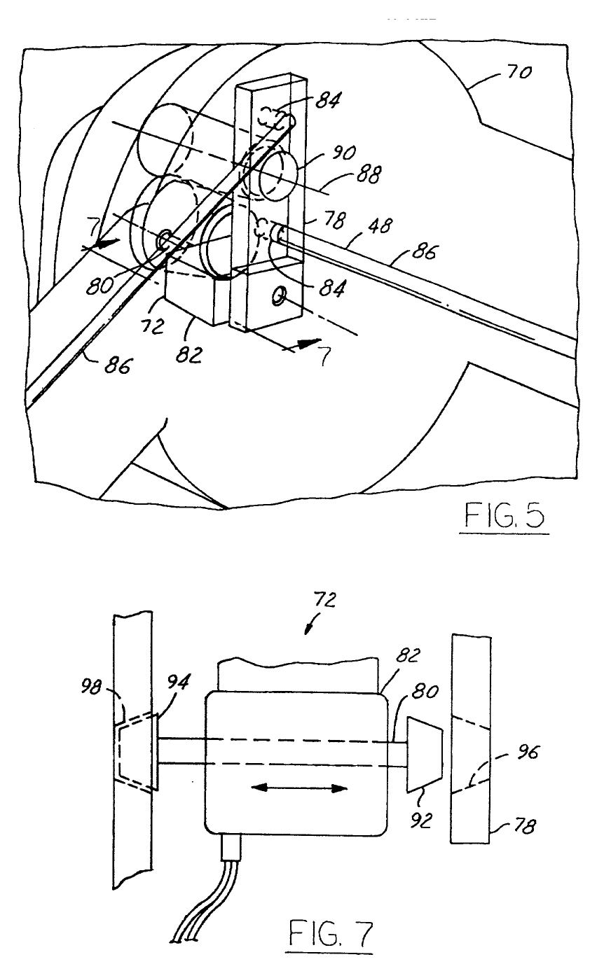

Referring now to FIGS. 5, 6, and 7 a top view of the second steering mechanism 38 coupled to the retractable steering arm 25, a perspective view of a central hub assembly 70, and a side view of a locking mechanism 72 are shown in accordance with an embodiment of the present invention, respectively. The second steering mechanism 38 includes the central hub assembly 70 coupled between a first extending arm 74 and a second extending arm 76. The extending arms 74 and 76 may have various switches or controls for operating the vehicle systems, similar to that of the portions 56 and 58.

The central hub assembly 70 contains the locking mechanism 72 for locking the first steering mechanism 36 to the second steering mechanism 38. The central hub assembly 70 may also contain control devices, horn electronics, an air bag, or other devices known in the art.

The locking mechanism 72 includes a locking member 78, a locking pin 80, and a locking pin actuator 82. The locking member 78 has two linkage attachment points 84 for a pair of linkage arms 86 in the linkage assembly 48. The linkage arms 86 extend within the extending arms 74 and 76 between the attachment points 84 and the pivot points 50 and 52. Locking member 78 rotates about a central pivoting axis 88 on a pivot pawl 90. The locking pin 80 has two conically shaped ends 92 and 94 for engaging in either the locking member 78 or the arm 25. The ends 92 and 94 may of course be of various size, shape, and style.

When the locking switch 40 is in the first state, the actuator 82 is signaled by the controller 22 to extend the locking pin 80, such that the first end 92 engages into a corresponding conically shaped opening 96 in the locking member 78, to lock the first steering mechanism 36 to the second mechanism 38. When the locking switch 40 is in the second state the actuator is signaled to extend the locking pin 80, such that the second end 94 engages into a corresponding conically shaped opening 98 of the arm 25, to lock the second steering mechanism 38 to the arm 25. In the first state, the combined steering mechanism 42 rotates about the center hub axis 43. In the second state, the hub assembly is fixed to the arm 25 and the first steering mechanism 36 is used to steer the vehicle 14, as briefly described above and as further described below. The openings 96 and 98 may be of various size and shape to correspond with the ends 92 and 94.

The actuator 82 may be a rack-and-pinion style actuator, a solenoid, or may be of other actuator type or style known in the art. Similarly, the steering arm motor 30 may also be an actuator of any type or style known in the art.

Referring now to FIG. 8, a schematic flow diagram illustrating a method of operating the dual-mode steering system 12 in accordance with an embodiment of the present invention is shown. The method is split into a method of operably using the steering mechanism 20 to guide the vehicle 14 and a method of storing the steering mechanism 20. The method of operably using the steering mechanism 20, includes manually switching locking switch 40, such that it is in the first state or the second state, as generally indicated by reference number 100.

The controller 22 locks the first steering mechanism 36 to the second steering mechanism 38 to form the combined steering mechanism 42 when the locking switch 40 is in the first state, as generally indicated by reference number 102. The controller 22 signals the actuator 82 to extend the locking pin 80 into engagement with the locking member 78.

The operator 24 may rotate the combined steering mechanism 42, upon locking the first steering mechanism 36 to the second steering mechanism 38, as generally indicated by reference number 104.

The controller 22 unlocks the first steering mechanism 36 from the second steering mechanism 38 when the locking switch is in the second state, as generally indicated by reference number 106. The controller 22 signals the actuator 82 to extend the locking pin 80 into engagement with the arm 25.

The operator 24 may rotate the first steering mechanism 36 when, upon locking the second steering mechanism 38 to the arm 25, as generally indicated by reference number 108.

The method of storing the steering mechanism 20 includes decelerating the vehicle 14 to a standstill, as generally indicated by reference number 110. Velocity of the vehicle 14 is reduced to zero. The storing of the steering mechanism 20 may proceed from the method of operably using the steering mechanism 20, as illustrated, or may be performed before or during the method of operably using the steering mechanism 20.

A vehicle transmission (not shown) of vehicle 14 is shifted to a locked standstill position, sometimes referred to as a parked position, as generally indicated by reference number 112. The function of shifting a transmission to a parked position may be different depending upon the vehicle style and type. For example, an electric vehicle may be locked in a standstill position differently from a vehicle having a traditional combustion engine and multiple speed transmission.

The arm switch 28 is toggled by the operator 24 to retract the arm 25 and position the steering mechanism 20 in the storage condition 34, as generally indicated by reference number 114. The steering mechanism 20 is preferably only retractable when the vehicle 14 is at a standstill or when the vehicle 14 is in an automated driving mode. The steering mechanisms 36 and 38 are also preferably retractable when the first steering mechanism 36 is locked to the second steering mechanism 38 to assure proper alignment of the combined steering mechanism 42 for storage. The operator 24 may than use an area 116, best seen in FIG. 1, forward of the operator 24 and rearward of the steering mechanism 20 to operate a laptop computer or perform other tasks.

The present invention therefore provides a dual-mode steering system that satisfies both older and younger generations, while at the same time providing the advantages of joystick type steering. The present invention also provides increased vehicle interior space while the vehicle is at a standstill, by allowing the steering mechanisms to collapse into a housing on a vehicle instrument panel. The present invention also provides increased comfort due to the dual-mode and open nature of the steering mechanisms.

The above-described apparatus, to one skilled in the art, is capable of being adapted for various purposes and is not limited to the following systems: automotive vehicle systems, control systems, hybrid-electric vehicle systems, navigation systems, or other applications utilizing a steering or vehicle guidance device. The above-described invention may also be varied without deviating from the spirit and scope of the invention as contemplated by the following claims.

What is claimed is:

1. A dual-mode steering system for an automotive vehicle comprising:
a first steering mechanism comprising;
an articulatable member;
a second steering mechanism comprising;
a center hub assembly; and
a first extending arm mechanically coupled to said articulatable member and said central hub assembly;
a locking mechanism mechanically coupled to said first steering mechanism and said second steering mechanism;
a locking switch having a first state and a second state; and
a controller electrically coupled to said locking mechanism and said locking switch, said controller locking said first steering mechanism to said second steering mechanism when said locking switch is in said first state and disengaging said first steering mechanism from said second steering mechanism when said locking switch is in said second state.

2. A system as in claim 1 wherein said dual-mode steering system incorporates drive-by-wire technology in steering the vehicle.

3. A system as in claim 1 wherein said first steering mechanism articulates in a lateral direction perpendicular to a centerline that extends along the length of the vehicle.

4. A system as in claim 1 wherein said first steering mechanism when locked to said second steering mechanism forms a combined steering mechanism, which is rotatable about a center hub axis.

5. A system as in claim 1 wherein said locking mechanism further comprises:
a locking member rotatable on a central pivoting axis;
a locking pin engagable in said locking member and said central hub assembly;
a linkage assembly mechanically coupled to said articulating member and said locking member; and
an actuating mechanism mechanically coupled to said locking pin and electrically coupled to said controller;
said controller engaging said locking pin in said locking member or disengaging said locking pin from said locking member when said locking switch is in said first state or said second state, respectively.

6. A system as in claim 5 wherein said central hub assembly comprises said locking member, said locking pin, and said actuating mechanism.

7. A system as in claim 1 further comprising:
a steering system housing;
said first steering mechanism and said second steering mechanism are retractable into said steering system housing.

8. A system as in claim 1 wherein said first steering mechanism and said second steering mechanism are retractable into said steering system housing when said first steering mechanism is locked to said second steering mechanism.

9. A system as in claim 1 wherein said second steering mechanism is disengaged when said locking switch is in said first state.

10. A system as in claim 1 wherein said first steering mechanism is disengaged when said locking switch is in said second state.

11. A dual-mode steering system for an automotive vehicle comprising:
a first steering mechanism comprising;
a first articulatable member;
a second articulatable member; and
a linkage assembly mechanically coupled to said first articulatable member and said second articulatable member;
a second steering mechanism comprising;
a center hub assembly;
a first extending arm mechanically coupled to said first articulatable member and said central hub assembly; and
a second extending arm mechanically coupled to said second articulatable member and said central hub assembly;
a locking mechanism mechanically coupled to said linkage assembly;
a locking switch having a first state and a second state; and
a controller electrically coupled to said locking mechanism and said locking switch, said controller locking said first steering mechanism to said second steering mechanism when said locking switch is in said first state and disengaging said first steering mechanism from said second steering mechanism when said locking switch is in said second state.

12. A system as in claim 11 further comprising:
a connecting member mechanically coupling said first articulatable member to said second articulatable member.

13. A system as in claim 11 wherein said first articulatable member and said second articulatable member articulate in a synchronous manner.

14. A system as in claim 11 further comprising:
a steering system housing;
said first steering mechanism and said second steering mechanism are retractable into said steering system housing.

15. A system as in claim 11 wherein said locking mechanism comprises:
a locking member rotatable on a central pivoting axis;
a locking pin engagable in said locking member and said central hub assembly;
a locking linkage mechanically coupled to said articulating member and said locking member; and
an actuating mechanism mechanically coupled to said locking pin and electrically coupled to said controller;
said controller engaging said locking pin in said locking member or disengaging said locking pin from said locking member when said locking switch is in said first state or said second state, respectively.

16. A system as in claim 11 wherein said second steering mechanism is disengaged when said locking switch is in said first state and said first steering mechanism is disengaged when said locking switch is in said second state.

17. A method of operating a dual-mode steering system for an automotive vehicle comprising:
switching a locking switch to a first state or a second state;
locking a first steering mechanism to a second steering mechanism to form a combined steering mechanism or unlocking said first steering mechanism from said second steering mechanism when said locking switch is in said first state or said second state, respectively; and
rotating said combined steering mechanism or rotating said first steering mechanism when said locking switch is in a first state or a second state, respectively, to steer the vehicle.

18. A method as in claim 17 wherein locking a first steering mechanism to a second steering mechanism comprises:
switching said switch to said first state; and
actuating a locking pin to engage in a locking member.

19. A method as in claim 17 wherein unlocking said first steering mechanism to a second steering mechanism comprises:
switching said switch to said second state; and
actuating a locking pin to engage in a retractable steering arm.

20. A method as in claim 17 further comprising:
retracting said combined steering mechanism when a transmission is in park.
